(19) United States
(12) Patent Application Publication
(10) Pub. No.: US 2015/0091449 A1
(43) Pub. Date: Apr. 2, 2015

(54) LIGHT-SENSING ILLUMINATION SYSTEM

(71) Applicant: Deborah Lemon, Carrollton, TX (US)

(72) Inventor: Deborah Lemon, Carrollton, TX (US)

(21) Appl. No.: 14/563,393

(22) Filed: Dec. 8, 2014

Related U.S. Application Data
(63) Continuation-in-part of application No. 14/180,796, filed on Feb. 14, 2014.
(60) Provisional application No. 61/765,974, filed on Feb. 18, 2013.
(60) Provisional application No. 62/013,766, filed on Jun. 18, 2014.
(60) Provisional application No. 61/913,566, filed on Dec. 9, 2013.

(51) Int. Cl. H05B 37/02; F21V 21/088; F21V 21/08; H05B 33/08

(52) U.S. Cl. CPC H05B 37/0218; H05B 37/0281; H05B 33/0854; F21V 21/088; F21V 21/0832; F21V 21/0808
USPC 315/158

(57) ABSTRACT

In one aspect, the present invention relates to an illumination system including a power source, a light source electrically coupled to the power source, and a light sensor electrically coupled to the power source and the light source. The light sensor activates the light source responsive to a pre-determined minimum-lumen threshold being reached. The illumination system is placed inside an interior of a dark area.

This application claims priority to, and incorporates by reference, for any purpose, the entire disclosure of U.S. Provisional Patent Application No. 61/913,566, filed Dec. 9, 2013 and U.S. Provisional Patent Application No. 62/013,766, filed Jun. 18, 2014. This application is a continuation-in-part of, and incorporates by reference, U.S. patent application Ser. No. 14/180,796, filed Feb. 14, 2014. U.S. patent application Ser. No. 14/180,796 claims priority to U.S. Provisional Patent Application No. 61/765,974, filed Feb. 18, 2013.

### BACKGROUND

1. Field of the Invention

The present application relates generally to illumination systems and more particularly, but not by way of limitation, to dark-area-illumination systems (“DAIS”) utilizing both a light source and a light sensor coupled thereto. The DAIS may, in one embodiment, be connected to an object, such as keys, which are often disposed inside, for example, a dark interior of a purse. In another embodiment, the DAIS may be connected to a lighting system for the dark area, such as, for example, a closet.

2. History of the Related Art

Dark areas requiring illumination are found frequently in the home and in the workplace. Dark areas include closets, attic spaces, basements, crawl spaces, and the like. Other examples of dark areas include containers such as purses, handbags, briefcases, and backpacks, which are very prevalent and useful to both children and adults alike. Frequently, dark areas do not permit infiltration of ambient light thereby reducing ambient illumination of the dark areas, particularly in low-ambient-light conditions. This can present problems when trying to locate objects such as, for example, a set of keys disposed within, for example, a dark purse.

Illumination systems have been developed and integrated into various articles such as purses, handbags, briefcases, backpacks, and the like to provide illumination when the article is opened. Such illumination systems frequently utilize various types of user-actuated switches to activate a lamp. For example, U.S. Pat. No. 8,147,086 discloses a purse light with a touch-sensitive switch. The purse light includes a light-emitting portion, a power source, and a touch-sensitive switch. U.S. Pat. No. 7,246,915 discloses a receptacle illumination device. The device includes a light-emitting membrane electrically connected to a power supply and a switch. U.S. Pat. No. 6,508,568 discloses a light assembly for an interior of a purse. The light assembly includes an illumination source, a power source, and a switch assembly. U.S. Pat. No. 4,954,934 discloses a purse light having a switch that actuates a battery-powered light when the switch is in an “on” position. Finally, U.S. Pat. No. 4,934,790 discloses a purse-light system having an illumination lamp that is activated for a pre-determined period of time by closing a momentary-contact switch.

Switch-actuated illumination systems rely on a user's ability to find and actuate a switch. Such a task may be made considerably more difficult in low-ambient-light environments such as a darkened closet or a darkened movie theater.

### SUMMARY

The present application relates generally to illumination systems and more particularly, but not by way of limitation to a DAIS utilizing a light sensor to turn a light source on. In one aspect, the DAIS is adapted for coupling to keys or the like to facilitate the location thereof. The DAIS includes a power source, a light source electrically coupled to the power source, and at least one light sensor electrically coupled to the power source and the light source. The light sensor activates the light source responsive to detected ambient lighting being within a predefined operational range. This light sensor is deactivated responsive to ambient lighting being outside of the predefined operational range. The DAIS placed inside an interior of a dark area to facilitate finding at least one object located within the dark area.

In another aspect, the present invention relates to a method for providing illumination to an interior of a dark area, such as a closet. The method includes placing a DAIS into an interior of a dark area and connecting the DAIS to either an independent light source and/or an electrical system servicing the dark area. The method further includes determining if a pre-determined minimum-lumen threshold has been reached. Responsive to the pre-determined minimum-lumen threshold being reached, a light source is activated. The light source is then deactivated after a period of time, which may be variable and used in combination with other light-activation and de-activation systems.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a schematic diagram of a DAIS according to an exemplary embodiment;

FIG. 2 is a perspective view of the DAIS of FIG. 1 according to an exemplary embodiment;

FIG. 3 is a front view of the DAIS of FIG. 1 according to an exemplary embodiment;

FIGS. 4A-4D are rear views of the DAIS of FIG. 1 according to various exemplary embodiments;

FIG. 5A is a flow diagram of a process for providing illumination to an interior of a dark area according to an exemplary embodiment;

FIG. 5B is a flow diagram of a process for providing illumination to an interior of a dark area utilizing a timer according to an exemplary embodiment;

FIG. 6A is a perspective front view of a DAIS according to an exemplary embodiment;

FIG. 6B is a bottom plan view of the DAIS of FIG. 6a according to an exemplary embodiment;

FIG. 6C is a rear plan view of the DAIS of FIG. 6a according to an exemplary embodiment;

FIG. 6D is a side plan view of the DAIS of FIG. 6a according to an exemplary embodiment;

FIG. 6E is a front plan view of the DAIS of FIG. 6a according to an exemplary embodiment;

FIG. 6F is a top plan view of the DAIS of FIG. 6a according to an exemplary embodiment;

FIG. 6G is a rear perspective view of the DAIS of FIG. 6a according to an exemplary embodiment;

FIG. 7A is a front exploded view of a DAIS according to an exemplary embodiment;

FIG. 7B is a rear exploded view of a DAIS according to an exemplary embodiment; and

FIG. 8 is a circuit diagram of a DAIS according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

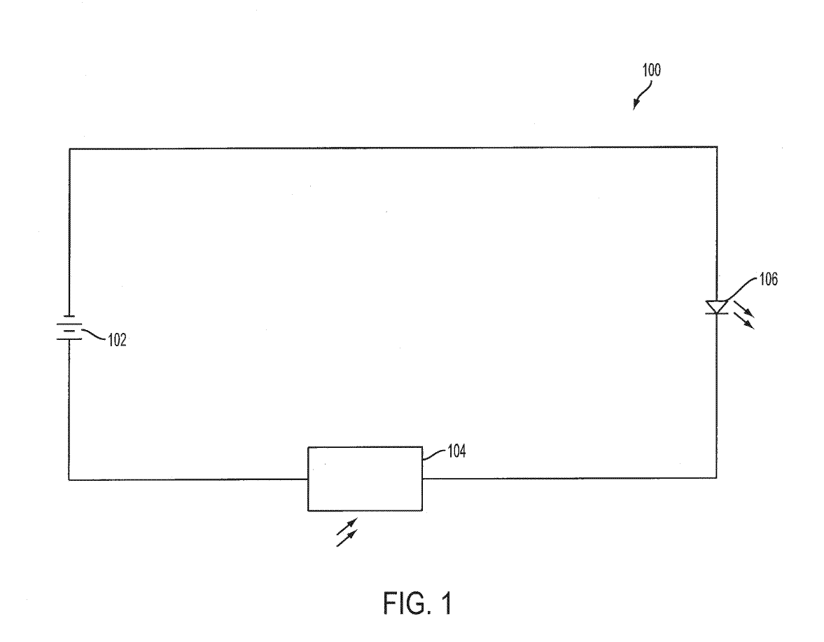

FIG. 1 is a schematic diagram of a DAIS according to an exemplary embodiment. A DAIS 100 includes a power source 102, at least one light sensor 104 electrically coupled to the power source 102, and a light source 106 electrically coupled to the power source 102 and the at least one light sensor 104. The light source 106 is illustrated by way of example in FIG. 1 as a light-emitting diode (LED); however, illumination systems utilizing principles of the invention may include, for example, an incandescent lamp, a halogen lamp, a fluorescent lamp, a cold-cathode gas-discharge lamp, or any other appropriate light source. In a typical embodiment, the light source 106 emits soft white visible light; however, in other embodiments, the light source 106 may emit visible light of any color. For example in light-sensitive conditions such as, for example, a photographic dark room, other colors of visible light such as, for example, red, may be utilized. In a typical embodiment, the at least one light sensor 104 is a photovoltaic cell; however, illumination systems utilizing principles of the invention may include, for example, a photo-transistor, a photo-resistor, or any other appropriate device. By way of example, the power source 102, the light sensor, 104, and the light source 106 are illustrated in FIG. 1 as being connected in series; however, in other embodiments, the power source 102, the at least one light sensor 104, and the light source 106 may be connected in any appropriate arrangement. In various embodiments, the DAIS 100 includes, for example, two light sensors 104 thereby facilitating measurement of ambient light without regard to placement or orientation of the DAIS 100.

During operation, the at least one light sensor 104 detects a level of ambient light. When the level of ambient light rises above a minimum-lumen threshold of a pre-determined operational range, the at least one light sensor 104 activates the light source 106 and visible light is emitted from the light source 106. If the level of ambient light is above a maximum lumen threshold of the pre-determined operational range, the at least one light sensor 104 does not activate the light source 106 so as to conserve the power source 102. During periods where the level of ambient light is below the minimum-lumen threshold, the at least one light sensor 104 does not activate the light source 106 and no visible light is emitted from the light source 106. In a typical embodiment, the power source 102 is an electro-chemical cell such as, for example, a nickel-cadmium battery, a lithium-ion battery, or the like. In other embodiments, the power source 102 may be, for example, a photo-voltaic cell or other appropriate power source. In a typical embodiment, the power source 102 is at least one of rechargeable and replaceable. In an exemplary embodiment, the power source 102 includes a connection (not shown). The connection allows the power source 102 to be recharged via, for example, a car, a computer, or an electrical outlet. In some embodiments, the connections may allow a user, via, for example, a computer, to configure an illumination time of the light source 106 or a color of the light source 106. The connection may also allow the user to configure the light source 106 to function as a strobe light. In a typical embodiment, the connection is, for example, a universal serial bus (USB) connection, a micro-USB connection, a connection via a wireless protocol such as, for example Bluetooth®, or any other appropriate connection.

In another exemplary embodiment, the power source 102 is rechargeable via electromagnetic charging. A power station (not shown) is connected to an electrical outlet. The DAIS 100 is received and charged by the charging station. An electromagnetic connection holds the DAIS 100 to the charging station.

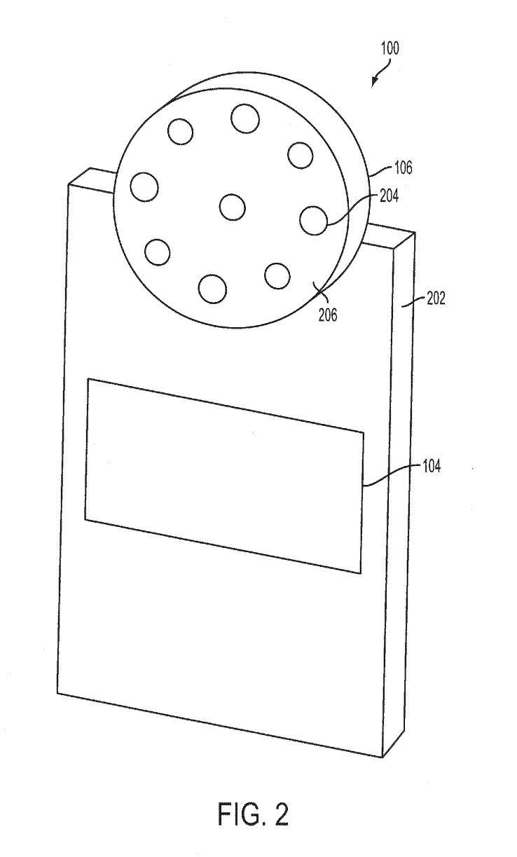

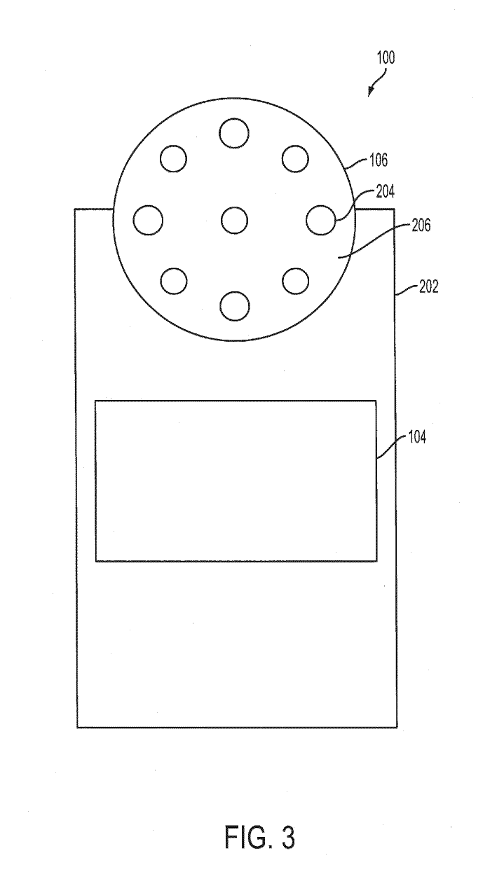

FIG. 2 is a perspective view of the DAIS of FIG. 1 according to an exemplary embodiment. FIG. 3 is a front view of the DAIS of FIG. 1 according to an exemplary embodiment. Referring to FIGS. 2-3, the DAIS 100 includes the light source 106 and a housing 202. In a typical embodiment, the housing 202 contains the power source 102 (shown in FIG. 1). The at least one light sensor 104 is formed on a front surface of the housing 202. In a typical embodiment, the housing 202 is sized to fit inside a purse, handbag, briefcase, backpack, or other dark area. In an exemplary embodiment, the housing 202 may be sized to be approximately 2 inches tall, approximately 1 inch wide, and approximately 0.25 inches thick. However, in other embodiments, the housing 202 may be of any appropriate size or shape such as, for example, cylindrical, triangular, or other appropriate shape.

As shown in FIGS. 2-3, the light source 106 includes a light array 204. The light array 204 is shown by way of example in FIGS. 2-3 as including nine lamps arranged in a generally circular pattern. In other embodiments, illumination systems utilizing principles of the invention may include light arrays including any number of lamps. In some embodiments, a reflective surface 206 may be disposed behind the light array 204. In a typical embodiment, the reflective surface 206 directs light emitted from the light array 204 in a generally forward direction. In some embodiments, the reflective surface 206 may be omitted. In various embodiments, a filter (not shown) may be utilized to adjust the color of light emitted from the light array 204.

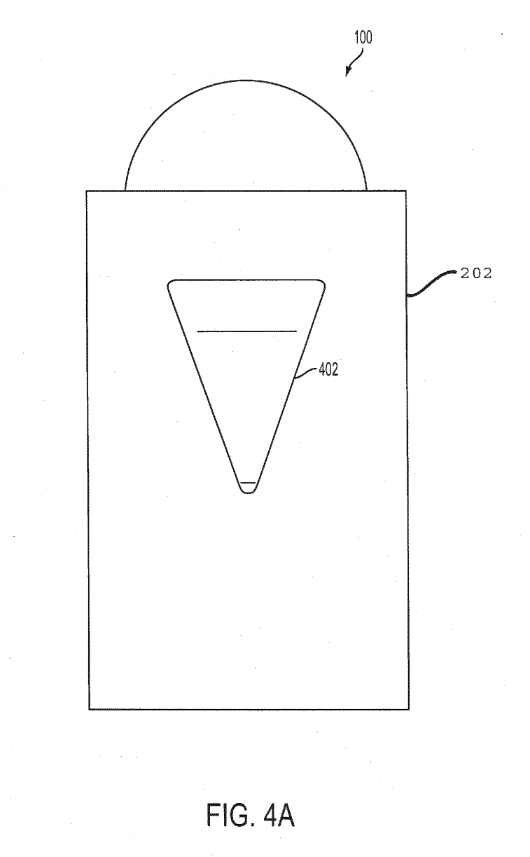

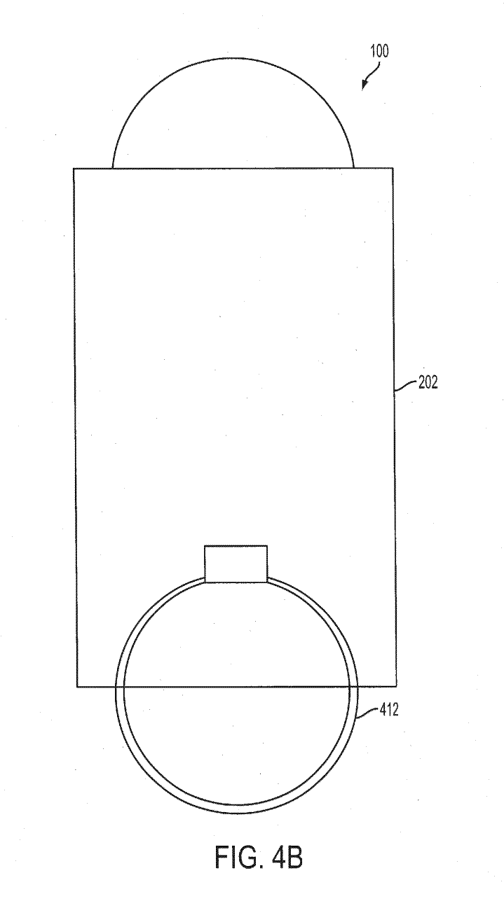

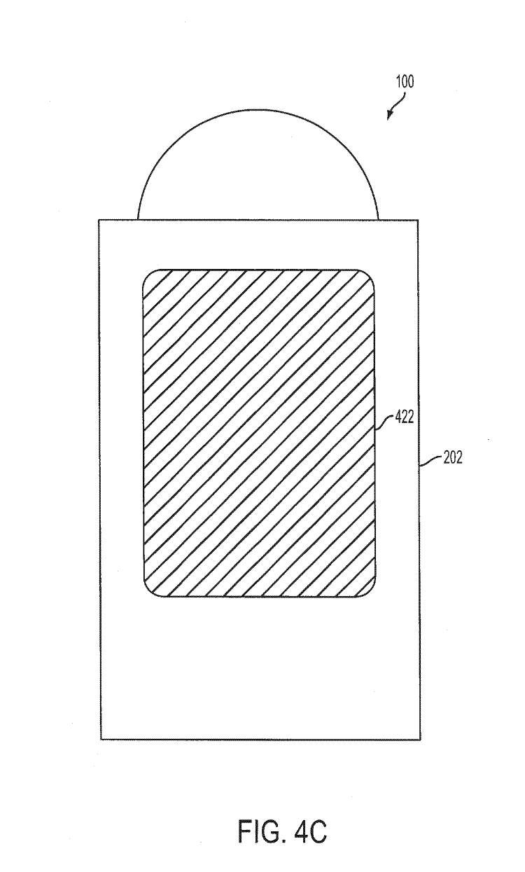

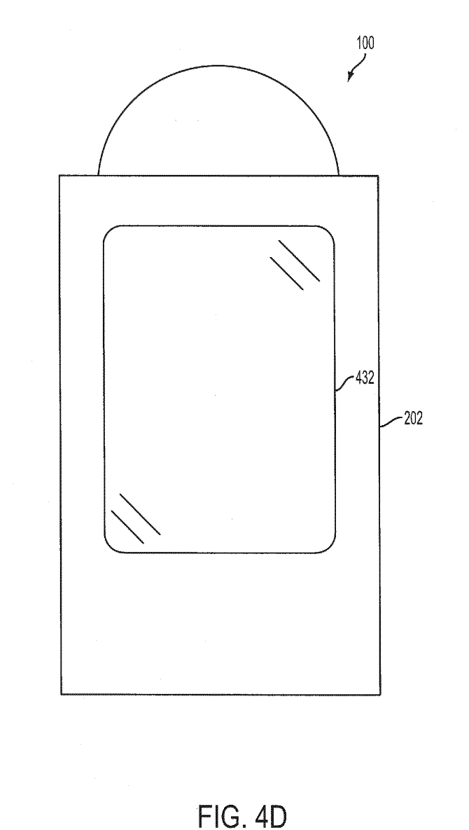

FIGS. 4A-4D are rear views of the DAIS of FIG. 1 according to various exemplary embodiments. As shown in FIG. 4A, a clip 402 is disposed on a rear surface of the housing 202. In a typical embodiment, the clip 402 may be, for example, a chain, a lobster claw jewelry clasp, a spring clip, a carabiner, or any other appropriate device. During operation, the clip 402 is utilized to secure the DAIS 100 with a dark area (not explicitly shown) such as, for example, an attic, a closet, a basement, a crawl space, a photographic dark room, a purse, a diaper bag, a briefcase, a suitcase, a gym bag, a pet accessory bag, a cloth grocery bag, a tote bag, a makeup bag, an overnight bag, a map case, a locker, a backpack, a lunch bag, a flight bag, an emergency medical kit, a laundry bin, a storage box, a camera bag, a hobby container, a picnic basket, an outdoor equipment container, a closet, a cabinet, a desk drawer, a chest, a trunk, and the like. In other embodiments, the clip 402 is utilized to secure the DAIS to an object such as, for example, a set of keys.

As shown in FIG. 4B, a ring 412 such as, for example, a key ring is coupled to the rear surface of the housing 202. The ring 412 facilitates attachment of the DAIS 100 to the interior of the dark area (not explicitly shown). Alternatively, the ring 412 facilitates attachment of the DAIS to an object such as, for example, a set of keys, which is typically placed inside a dark area. As shown in FIG. 4C, a fastener 422 is coupled to the rear face of the housing 202. In a typical embodiment, the fastener 422 may be, for example, a hook and pile fastener such as Velcro™, or an adhesive fastener such as a double-sided adhesive. As shown in FIG. 4D, a magnet 432 is coupled to the rear face of the housing 202. The magnet 432 facilitates attachment of the DAIS 100 to the interior of the dark area.

Referring to FIGS. 1-4D, during operation, the DAIS 100 is placed within an interior of a dark area (not shown). If the level of ambient light is below the pre-determined minimum-lumen threshold, such as, for example, during periods when the dark area is closed, the at least one light sensor 104 does not activate the light source 106 and no visible light is emitted from the light source 106. When the level of ambient light produced outside the dark area rises above the pre-determined minimum-lumen threshold, such as when the dark area is opened, the at least one light sensor 104 activates the light source 106.

In various embodiments, an amount of illumination provided by the light source 106 may be varied according the level of ambient light. For example, if the user is in low light conditions, such as a darkened movie theater, the light source 106 may emit less light than if the user were in well-lit conditions.

In other embodiments, the DAIS 100 includes a motion sensor (not shown). During operation, the at least one light sensor 104 detects if ambient light is within the pre-defined operational range. If ambient light is detected within the pre-defined operational range, the light source 106 is activated. Concurrent with activation of the light source 106, the motion sensor is also activated. The motion sensor detects motion in the vicinity of the DAIS 100 as would be the case, for example, if a user was searching for keys in a dark area such as, for example, a purse. When the motion sensor ceases to detect motion in the vicinity of the DAIS 100 for a period of time such as, for example, 5 seconds, the light source 106 is deactivated.

In still other embodiments, the DAIS 100 includes a body heat sensor (not shown). During operation, the at least one light sensor 104 detects if ambient light is within the pre-defined operational range If ambient light is detected within the pre-defined operational range, the light source 106 is activated. The body heat sensor detects body heat in the vicinity of the DAIS 100 as would be the case, for example, if a user was searching for keys in a dark area such as, for example, a purse. When the body heat sensor ceases to detect body heat in the vicinity of the DAIS 100 for a period of time such as, for example, 5 seconds, the light source 106 is deactivated.

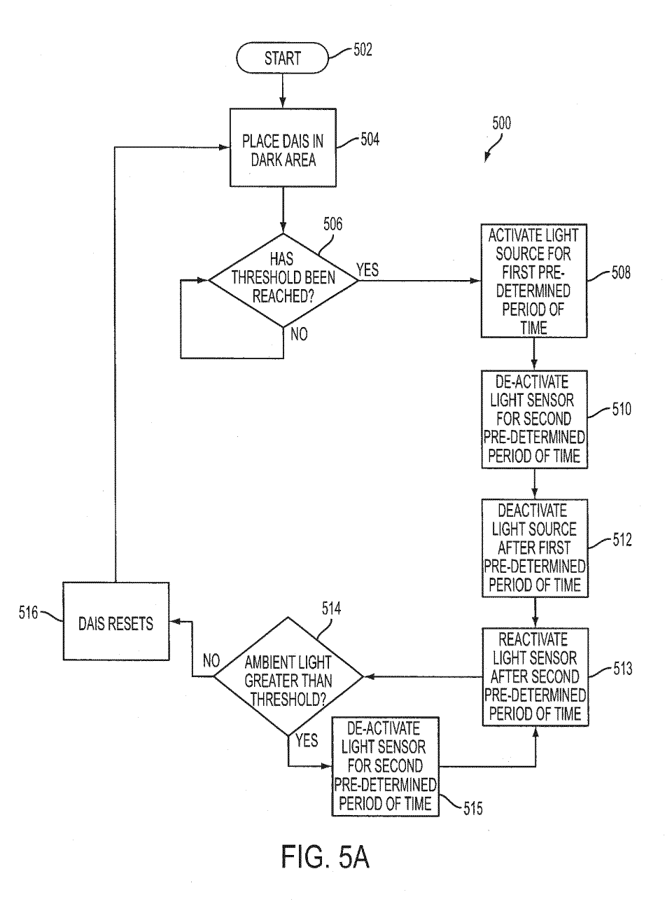

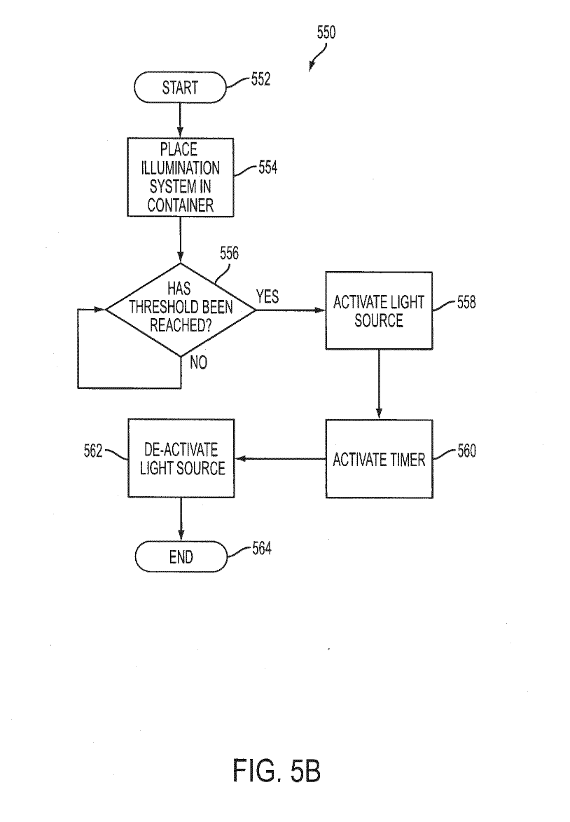

FIG. 5A is a flow diagram of a process for providing illumination to an interior of a dark area according to an exemplary embodiment. A process 500 begins at step 502. At step 504 the DAIS 100 is placed inside a dark area. In an exemplary embodiment, the DAIS 100 is attached to an object such as, for example, a set of keys, which is disposed within the dark area though this need not necessarily be the case. At step 506, the at least one light sensor 104 determines if a level of ambient light produced outside the dark area is within the pre-defined operational range. That is, the at least one light sensor 104 determines if a level of ambient light is above the minimum lumen threshold but below the maximum lumen threshold of the pre-defined operational range. At step 508, if the ambient light is within the pre-defined operational range, the at least one light sensor 104 activates the light source 106 for a first pre-determined period of time such as, for example, on the order of 20 seconds. In various embodiments, the first pre-determined period of time is variable.

At step 510, upon activation of the light source 106, the at least one light sensor 104 is deactivated for a second pre-determined period of time such as, for example 5 minutes. At step 512, the light source 106 is de-activated after the first pre-determined period of time. At step 513, the at least one light sensor 104 is re-activated after the second pre-determined period of time. At step 514, the at least one light sensor 104 determines if ambient light is present within the pre-defined operational range. At step 515, if the at least one light sensor 104, after re-activation, detects ambient light in an amount outside the pre-defined operational range, as would be the case if the DAIS 100 is removed from the dark area, the at least one light sensor 104 again deactivates and the light source 106 remains deactivated.

The at least one light sensor 104 remains deactivated for the second pre-determined period of time. Steps 512 through 514 are repeated until the at least one light sensor 104 detects ambient light within the pre-defined operational range. Such an arrangement allows the DAIS 100 to enter a “hibernation” period during times when the DAIS 100 is in areas of adequate illumination. In a typical embodiment, steps 512 through 514 are repeated, for example, three time. If, after three cycles, the DAIS 100 is remains in an area of adequate illumination, the at least one light sensor 104 deactivates to conserve the power source 106. At step 516, when the at least one light sensor 104 detects ambient light within the pre-defined operational range, as would be the case when the DAIS 100 is again placed into the dark area, the DAIS 100 resets and the process 500 returns to step 504.

FIG. 5B is a flow diagram of a process for providing illumination to an interior of a dark area utilizing a timer according to an exemplary embodiment. A process 550 begins at step 552. At step 554 the DAIS 100 is placed inside a dark area. In an exemplary embodiment, the DAIS 100 is attached to an object such as, for example, a set of keys, which is disposed within the dark area. In other embodiments, the DAIS 100 is placed inside a dark area such as, for example, a closet. In such embodiments, the DAIS may be electrically coupled to an electrical system servicing the dark area. At step 556, the at least one light sensor 104 determines if the pre-determined minimum-lumen threshold has been reached. At step 558, if the pre-determined minimum-lumen threshold has been reached, the at least one light sensor 104 activates the light source 106. In an exemplary embodiment, the light source 106 is directed to illuminate, for example, a light switch that is electrically coupled to a primary illumination system.

Still referring to FIG. 5B, upon activation, the light source 106 emits visible light in an amount greater than the pre-determined minimum-lumen threshold. At step 560, a timer is activated to measure a pre-determined amount of time. At step 562, when the timer reaches the pre-determined amount of time, the light source 106 is de-activated. The process 550 ends at step 564. Such an arrangement allows sufficient time for the user to locate, for example, the light switch.

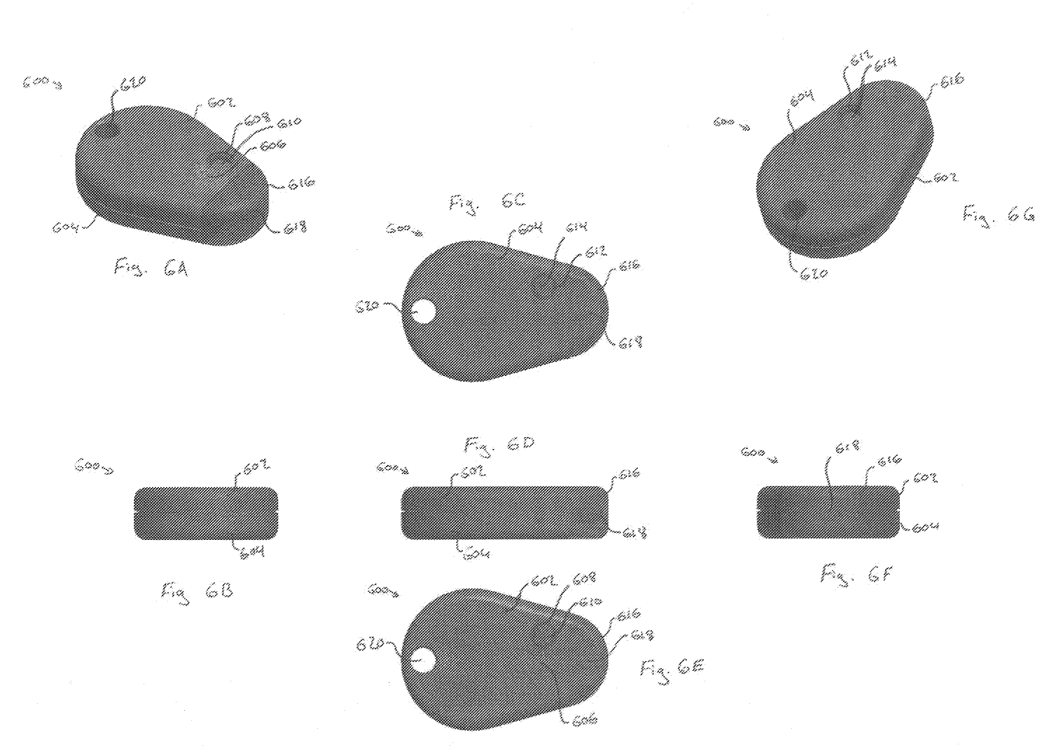

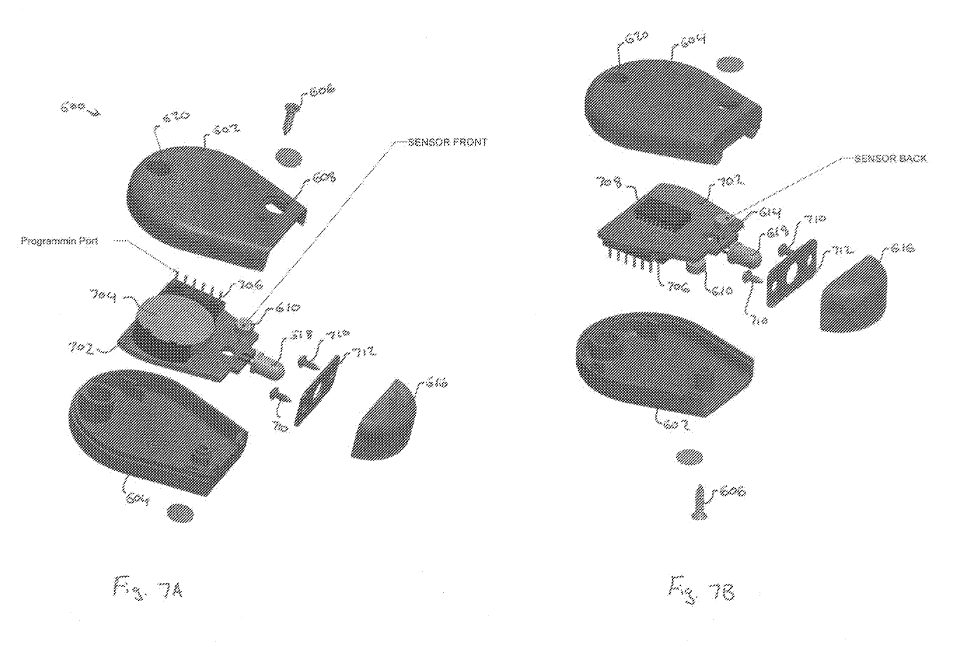

FIG. 6A is a perspective front view of a DAIS 600. FIG. 6B is a bottom plan view of the DAIS 600. FIG. 6C is a rear plan view of the DAIS 600. FIG. 6D is a side plan view of the DAIS 600. FIG. 6E is a front plan view of the DAIS 600. FIG. 6F is a top plan view of the DAIS 600. FIG. 6G is a rear perspective view of the DAIS 600. Referring to FIGS. 6A-6G together, the DAIS 600 includes a front cover 602 coupled to a rear cover 604 via a screw 606. A front aperture 608 is formed in the front cover 602. A first light sensor 610 is disposed in the front aperture 608. A rear aperture 612 is formed in the rear cover 604. A second light sensor 614 is disposed in the rear aperture 612. A lens 616 if coupled to a front of the front cover 602 and the rear cover 604 when the front cover 602 and the rear cover 604 are assembled together. A light-emitting diode (“LED”) 618 is disposed inwardly of the lens 616. A hole 620 is formed through the front cover 602 and the rear cover 604. In a typical embodiment, the hole 620 facilitates coupling of the DAIS 600 to, for example, a key ring or other attachment point.

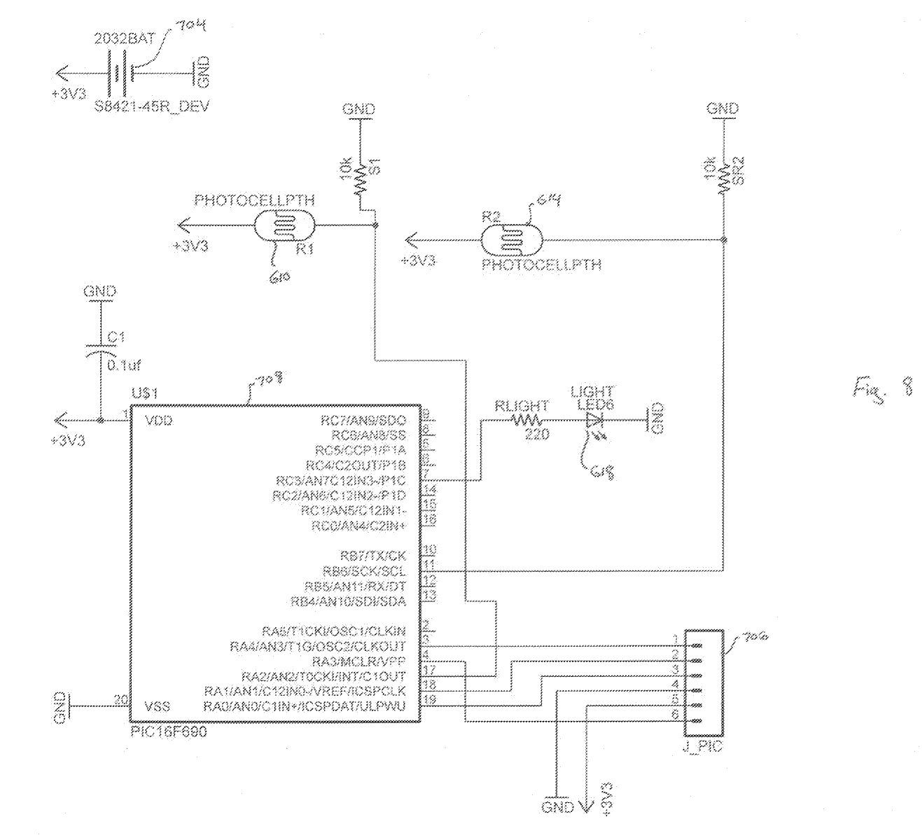

FIG. 7A is a front exploded view of the DAIS 600. FIG. 7B is a rear exploded view of the DAIS 600. Referring to FIGS. 7A-7B together, a circuit board 702 is disposed internally of the front cover 602 and the rear cover 604. As shown in FIG. 7A, the first light sensor 610 is electrically coupled to the circuit board 702. A battery 704 and a programming port 706 are also electrically coupled to the circuit board 702. In a typical embodiment, the battery 704 is, for example, a 3V watch-style battery; however, in other embodiments, batteries of various sizes, shapes, and voltages may be utilized. In a typical embodiment, programming port 706 facilitates electrical connection of the DAIS 600 with, for example, a personal computer. The programming port 706 allows a minimum-light threshold to be programmed as well as a luminous intensity of the LED 618.

Still referring to FIGS. 7A and 7B, a processor 708 is coupled to the circuit board 702 on a side opposite the battery 704 and the programming port 706. Similarly, the second light sensor 614 is coupled to the circuit board 702 on the same side as the processor 708. The LED 618 is electrically coupled to the circuit board 702 at a front region thereof. During operation, the front cover 602 and the rear cover 604 are coupled to each other enclosing the circuit board 702 therein. The front cover 602 and the rear cover 604 are secured to each other via the screw 606. The lens 616 is disposed on the front of the front cover 602 and the rear cover 604. The lens 616 surrounds the LED 618 and is secured to the front cover 602 and the rear cover 604 by a plurality of screws 710. In a typical embodiment, a front plate 712 is positioned behind the lens 616 and around the LED 618. The front plate 712 is connected to the front cover 602 and the rear cover 604 and provides an attachment point for the plurality of screws 710.

FIG. 8 is a circuit diagram of the DAIS 600. The processor 708 is electrically coupled to the programming port 706, the first light sensor 610, the second light sensor 614, and the LED 618. In a typical embodiment, the processor 708 interprets signals from the first light sensor 610 and the second light sensor 614. The processor 708 provides electrical signals to activate and deactivate the LED 618.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. An illumination system comprising:
a power source;
a light source electrically coupled to the power source;
a light sensor electrically coupled to the power source and the light source;
wherein the light sensor activates the light source responsive to ambient light being within a pre-defined operational range; and
wherein the illumination system is placed into an interior of a dark area.

2. The illumination system of claim 1, wherein the light source includes a light array.

3. The illumination system of claim 1, wherein the light source includes a light-emitting diode.

4. The illumination system of claim 1, comprising a universal serial bus connection.

5. The illumination system of claim 4, wherein the universal serial bus connection charges the power source.

6. The illumination system of claim 4, wherein the universal serial bus connection facilitates programming of the power source.

7. The illumination system of claim 1, comprising a clip.

8. The illumination system of claim 1, comprising a ring.

9. The illumination system of claim 1, comprising a fastener.

10. A method for providing illumination to an interior of a dark area, the method comprising:
placing an illumination system into an interior of a dark area;
determining if ambient illumination is within a pre-defined operational range;
responsive to the ambient illumination being within the pre-defined operational range, activating a light source and deactivating the light source for a per-determined period of time;
emitting light from the light source in an amount greater than the pre-determined operational range.

11. The method of claim 10, wherein, after the emitting, assessing if the ambient light remains within the pre-defined operational range.

12. The method of claim 11, wherein the assessing comprises:
reactivating the light sensor after the pre-determined period of time;
deactivating the light source after the pre-determined period of time.

13. The method of claim 12, wherein, responsive to an assessment that ambient light remains in the pre-defined operational range, reactivating the light source and deactivating the light sensor for the pre-determined period of time.

14. The method of claim 12, wherein responsive to an assessment that ambient light is outside of the pre-defined operational range, deactivating the light source.

15. The method of claim 10, wherein the pre-determined period of time is on the order of 20 seconds.

16. The method of claim 10, wherein the light source includes a light-emitting diode.

17. The method of claim 10, wherein the light source includes a light array.

18. An illumination system comprising:
a power source;
a light source electrically coupled to the power source;
a first light sensor electrically coupled to the power source and the light source;
a second light sensor electrically coupled to the power source and the light source, the second light sensor oriented differently from the first light sensor;
wherein at least one of the first light sensor and the second light sensor activates the light source responsive to ambient light being within a pre-defined operational range; and
wherein the illumination system is placed into an interior of a dark area.

19. The illumination system of claim 18, wherein the light source is a light-emitting diode.

20. The illumination system of claim 18, comprising a universal serial bus connection.
